(19) United States
(12) Patent Application Publication
(10) Pub. No.: US 2006/0177659 A1
(43) Pub. Date: Aug. 10, 2006

(54) Powder containing carbon nanotube or carbon nanofiber and process for preparing the same

(75) Inventors: Wen-Jauh Chen, Douliou City (TW); Wei-Long Liu, Douliou City (TW); Ting-Kan Tsai, Huwei Township (TW); Shu-Huei Hsieh, Tuku Township (TW); Jao-Jia Horng, Douliou City (TW)

Correspondence Address: LOWE HAUPTMAN BERNER, LLP, 1700 DIAGONAL ROAD, SUITE 300, ALEXANDRIA, VA, 22314, US

(73) Assignee: National Pingtung University of Science & Technology

(21) Appl. No.: 11/053,257

(22) Filed: Feb. 9, 2005

(51) Int. Cl. B32B 5/16

(52) U.S. Cl. 428/403; 977/773; 427/304; 427/443.1

(57) ABSTRACT

The invention provides a powder containing carbon nanotube or nanofiber and a process for producing the same. Said powder containing a carbon nanotube or nanofiber is composed of a carrier and a carbon nanotube or nanofiber. Said carrier is a micrometer-sized particle such as Al₂O₃, SiO₂, TiO₂, CaO, SiC, WC and an acrylic high molecular sphere. Said carbon nanotube or nanofiber is grown on the surface of the carrier by a chemical vapor deposition (CVD) method and their diameter is in a range of several nanometer to several hundreds nanometer. Said carbon nanotube or nanofiber is a multi-wall carbon nanotube (MWCNT) and is in a curved shape. Said process for producing said powder containing a carbon nanotube or nanofiber comprises a pretreatment, a sensitization treatment, an activation treatment, an electroless plating treatment and a growth treatment. Said powder containing a carbon nanotube or nanofiber can be applied for treating various pollutants in the environment, such as pollutants existing in air, water, sludge and soil.

### BACKGROUND OF THE INVENTION

1. Field of the Invention

The invention relates to a powder containing carbon nanotube or carbon nanofiber and a process for preparing the same, and in particular, to a powder comprising a carrier having a micrometer size and being coated with a layer of carbon nanotube or carbon nanofiber. Such powder containing carbon nanotube or carbon nanofiber is to be used primarily for treating pollutant in the environment.

2. Description of the Prior Art

Alongside the advance of the human civilization, numerous air pollution as well as water pollution has been occurred. “Air” and “water” are the essential sources needed for the survival of not only human being, but also other natural world. Air polluting materials include mainly particulate material and hazardous gas. The air polluting particulate material comprises essentially falling dust, soot and the like. The hazardous gas includes mainly SO₂, CO, NO, NO₂, organic gases and the like. Water pollution is derived largely from Cd, Pb, Sn, Cr(VI), Hg, organic phosphorous and the like. All these polluting substances can impact greatly on the health of human being. Accordingly, it becomes one of extremely important topics for the modern human being to purify air and water.

Many processes and techniques can be used for purifying air and water. For the purification of low concentration of hazardous substance, an adsorption process may be the most effective one. The adsorption process consists of treating a fluid mixture with a porous material such that one or more components in the fluid could be adsorbed on the surface of the porous material so as to be separated from other components. Such a porous material is known as an adsorbent. The research and application of an adsorbent has been undergone for a long time. The adsorption process has become an indispensable technique in the context of organic and petroleum chemical industries. Moreover, for the present environmental protection, the application of the adsorption process is increasingly more and more important and wider.

The adsorption is occurred by the residual attraction force present on the surface of the adsorbent and is generally classified into physical adsorption and chemical adsorption. While the physical adsorption is caused by the electrostatic force (or Van der Waals force) between the adsorbent and the adsorbate molecules, the chemical adsorption may be attributed to the chemical reaction between the adsorbent and the adsorbate molecules, and comprises the breakage and recombination of chemical bonds and hence produces adsorbing force higher than that from the physical adsorption.

At present, adsorbents extensively used in the industry include primarily four types, namely, the active carbon, the active alumina, the silicon gel, and the zeolite molecular sieve. The conditions that an adsorbent must have include: (1) a large surface area, especially, the inner surface area, (2) a selective adsorption, a particular strong attraction against to some components in the fluid, (3) a high adsorption capacity, and at specific temperature and adsorbate concentration, a high maximum adsorbable mass of the adsorbate per unit mass (or volume) of the adsorbent, which is dependent on the surface area, the pore size, the distribution of the pore size, the polarity of the molecule and the property of the function group, (4) a sufficient mechanical strength and chemical stability, and (5) a low prize, and the like.

As the active carbon, it is a disorder 3-dimensional material whose carbon atom has hybrid electronic structures of SP³ and SP². The active carbon has pores of 15˜25 Å inside, and a specific surface area of 600˜1600 m²/g. There has been long time for the application of the active carbon in de-odorizing, de-pigmentation, preservation, and waterproofing. Recently, it plays a more and more important role in environmental protection such as the purification of air and water.

The carbon nanotube and nanofiber are the isomer of the active carbon, contain carbon atom possessing SP² hybrid orbital and are one-dimensional material composed predominantly of single or multiple layers of crinkled graphite. Those having a diameter of less than 50 nm are known as the carbon nanotube, while those having a diameter of 50˜200 nm are nanofiber. The carbon nanotube or nanofiber has a variety of pore structure, including the central hole of a hollow tube/fiber, the pore between layers, and the void among tube/fibers. They possess a huge surface, and in general, the surface of a single-wall carbon nanotube comprises a simpler chemical structure, and a rather inert chemical property. Whereas the surface of a multi-wall carbon nanotube or nanofiber has a more complicated structure, possesses more defects and exhibits stronger chemical reactivity.

Based on the theoretical calculation, 1 g of a mono-layer graphite should have a specific surface area of 2630 m²/g, and, therefore, the specific surface area of a open-end single-wall carbon nanotube might be near 2630 m²/g. However, since the end of the tube of a single-wall has a great chance to be closed, and, further, a single-wall carbon nanotube tends to aggregate into a bundle, its surface area may reduce dramatically to an empirical value of 50˜300 m²/g. While a multi-wall carbon nanotube or nanofiber may exhibit a specific surface area less than that of a single-wall carbon nanotube, those stacked pores resulting from the stacking of tube/fibers with one another provide main contribution to the adsorption process in many cases. On conclusion, a carbon nanotube or nanofiber has an abundant surface and porous structures, while its carbon atom possesses an electronic structure different to that of an active carbon. Furthermore, its diameter is just less than several hundreds nm, indicating that its surface energy differs also to that of the active carbon. Based on these reason, the application of carbon nanotube or nanofiber in the field of the adsorption technology is increasingly more emphasized.

Heretofore, the process for the production of the carbon nanotube or nanofiber that has been applied in the field of the adsorption technology comprises generally of growing a carbon nanotube or nanofiber on a substrate sheet, collecting them by scratching, purifying the carbon nanotube or nanofiber thus scratched to remove the catalytic metal, amorphous carbon and impurities remained in the tube/fiber and opening the closed ends to increase the porosity and surface area of the tube/fiber. Further, it has been proposed to generate various functional groups or defect by various oxidation approaches to increase the adsorption capacity of the surface of the tube/fiber. The carbon nanotube or nanofiber produced in this manner has many disadvantages when its is applied in the adsorption field, which including: (1) easy to loss, since the carbon nanotube or nanofiber is collected by scratching from the substrate sheet, it is in a distinctly separate form and tends to loss in the fluid; (2) its producing process being rather troublesome, since the production process of the carbon nanotube or nanofiber comprises growing at first on a the substrate sheet, collecting by scratching from the substrate sheet, purifying, oxidization and the like, the step of scratching needs labor, while a long time must be spent in step of purification and oxidation; (3) a high production cost, as a general approach for producing a single-wall carbon nanotube or nanofiber comprises a process by taking advantage of discharging on a carbon electrode, and the production of multi-wall carbon nanotube or nanofiber comprises invariably plating a layer of catalyst on a substrate by vaporization plating, sputtering or electronic gun spray coating, these procedures must be carried out under a vacuum state, which indicating a relatively high expense in the associated equipment, operation cost, time and the like; and (4) a reduction of pores useful for adsorption, since the carbon nanotube or nanofiber is in a distinctly separate state, pores formed among the tubes/fibers can not sustained, which will degrade dramatically the adsorption capacity of the tube/fiber.

In order to solve the above-described problems, the invention is provided accordingly.

### SUMMARY OF THE INVENTION

The primary objective of the invention is to provide a powder, wherein said powder being composed of a carrier and a carbon nanotube or nanofiber. Said carrier is a particle of a size of an order of micrometer, and includes such as, for example, Al₂O₃, SiO₂, TiO₂, CaO, SiC, WC and the like. Said carbon nanotube or nanofiber has a diameter of from several nanometers to several hundreds nanometers, presents as a bending shape and is a multi-wall carbon nanotube (MWCNT).

Another objective of the invention is to provide a process for producing of a powder containing a carbon nanotube or nanofiber. Said process takes advantage primarily of electroless plating and a chemical vapor deposition techniques and comprises essential steps of pretreatment, sensitization, activation, electroless plating, growing and the like.

### BRIEF DESCRIPTION OF THE DRAWINGS

These features and advantages of the present invention will be fully understood and appreciated from the following detailed description of the accompanying Drawings.

FIG. 1 is a magnified image of Al₂O₃ carrier selected for used in the invention, wherein this image is obtained under a field emitting scanning electron microscope (FESEM) at a magnification of 20,000×, and shows the irregular shape of Al₂O₃ particles;

FIG. 2 is a magnified image of products formed by depositing Fe/Ni catalyst over the surface of Al₂O₃ carriers through an electroless plating technique according to the invention, wherein this image is obtained under a field emitting scanning electron microscope (FESEM) at a magnification of 100,000×, and shows that, since the plating time is short (about 10 minutes), the catalyst Fe/Ni nano-particles are deposited sparsely on the surface of the Al₂O₃ carrier;

FIG. 3 is a magnified image of products formed by depositing Fe/Ni catalyst over the surface of Al₂O₃ carriers through an electroless plating technique according to the invention, wherein this image is obtained under a field emitting scanning electron microscope (FESEM) at an magnification of 500,000×, and as the plating time is about 20 minutes here, it is can be seen that there are more catalyst Fe/Ni nano-particles deposited on the surface of the Al₂O₃ carrier;

FIG. 4 is a magnified image of products formed by first depositing Fe/Ni catalyst over the surface of Al₂O₃ carriers, followed by growing a carbon nanotube or nanofiber thereon according to the invention, wherein this image is obtained under a field emitting scanning electron microscope (FESEM) at a magnification of 20,000×, and shows the carbon nanotube or nanofiber is in a thin, elongate and curved shape, and there are numerous pores among carbon nanotube or nanofiber; and

FIG. 5 is a magnified image of products formed by first depositing Fe/Ni catalyst over the surface of Al₂O₃ carriers, followed by growing a carbon nanotube or nanofiber thereon according to the invention, wherein this image is obtained under a field emitting scanning electron microscope (FESEM) at a magnification of 50,000×, and shows the carbon nanotube or nanofiber has a length in an order of micrometers, and a diameter of several tens nanometer (nm);

### DETAILED DESCRIPTION OF THE PREFERRED EMBODIMENT

In order to achieve those objectives of the invention, a process for producing a powder containing a carbon nanotube or nanofiber is provided, said process comprising selecting particles with a size in the order of micrometer and using as a carrier. These particles exhibit certain characteristics such as chemical stability, no pollution to the environment, low cost and the like. Such particles include such as, for example, Al₂O₃, SiO₂, TiO₂, CaO, SiC, WC and the like. These carriers are cleaned by washing under shaking in an acidic solution containing HCl, H₂SO₄, HF and the like to remove dirt on the surface of the carrier and render atoms in the surface of the carrier into an activated state. Next, they are sensitized in a solution containing SnCl₂, followed by activated in a solution containing PdCl₂, so as to deposit a layer of catalytic substance over the surface of the carrier for facilitating the electroless plating of Fe, Co, Ni or alloy thereof. Thereafter, an electroless plating with a solution containing Fe, Co, or Ni ions is carried out to plate a metal layer of Fe, Co, Ni or alloy thereof on the surface of the carrier. Finally, a layer of carbon nanotube or nanofiber is grown on the surface of thus obtained carrier in an atmosphere containing a carbon source at proper temperature to obtain the powder containing a carbon nanotube or nanofiber according to the invention.

In order to understand thoroughly objects, technical features and advantages of the invention, a detailed description is given below with reference to several preferred embodiments thereof in conjunction with the accompanied figures.

### Examples

General Procedure

The process for producing a powder containing carbon nanotube or nanofiber according to the invention comprises following main steps:
(1) Pretreatment: A carrier is cleaned in a washing solution to remove dirt on the surface of the carrier, followed by rinsing in de-ionized water to remove the cleaning solution remained on the surface of the carrier, wherein said carrier is a ceramic particle such as, for example, alumina (Al₂O₃), silicon dioxide (SiO₂), titanium dioxide (TiO₂), calcium oxide (CaO), silicon carbide (SiC), tungsten carbide (WC), and the like, and the cleaning solution is an acidic solution containing hydrochloric acid (HCl), sulfuric acid (H₂SO₄), or hydrofluoric acid (HF), and wherein the removal of the cleaning solution remained on the surface of the carrier comprises a rinsing with shaking by a ultrasonic vibrator.
(2) Sensitization treatment: The carrier thus cleaned is placed in a sensitization solution to coating the carrier with a thin layer containing tin, followed by rinsing in de-ionized water to remove the sensitization solution remained on the surface of the carrier, wherein said sensitization solution is an aqueous solution containing stannous chloride (SnCl₂) and hydrochloric acid (HCl), and the sensitization operation comprises stirring with a stirrer.
(3) Activation treatment: The sensitized carrier is placed in an activation solution to deposit a layer of palladium over the surface of the carrier, followed by rinsing in de-ionized water to remove the activation solution remained on the surface of the carrier, wherein said activation solution is an aqueous solution containing palladium chloride (PdCl₂) and hydrochloric acid (HCl), and the activation operation comprises a stirring activation by a stirrer.
(4) Electroless plating: The activated carrier is placed in an electroless plating solution to plate a layer of metal or alloy catalyst on the surface of the carrier, followed by rinsing in de-ionized water to remove the electroless plating solution remained on the surface of the carrier, wherein said electroless plating solution is an aqueous solution containing one of Fe ion, Co ion, Ni ion, Fe ion and Co ion, Fe ion and Ni ion, Co ion and Ni ion, or Fe ion and Co ion and Ni ion and the like, and the electroless plating is carried out by stirring with a stirrer.
(5) Growing treatment: The electroless plated carrier is placed in a growth furnace to grow a carbon nanotube or nanofiber over the surface of the carrier in an atmosphere containing a carbon source, wherein said growth atmosphere is set to be an atmosphere of nitrogen (N₂), argon (Ar) or hydrogen (H₂), and the growth is proceeded as preheating at a temperature of 400˜800° C. for a period of time till the physical and chemical properties is uniform, said atmosphere contains a carbon source including CH₄, C₂H₂, C₃H₈, and C₂H₅OH gases, and wherein the gas to be supplied into the growth furnace can flow concurrently with the input of N₂, H₂, or Ar gases, and wherein the pressure in the growth furnace may be an normal pressure or a pressure less than a normal pressure and the temperature for growing carbon nanotube or nanofiber may be in the range of 600° C. to 900° C.

The invention will be described now in further detailed with the following non-limiting examples.

Example

In this example, Al₂O₃ particles were used as the carrier. Said Al₂O₃ particles has a size in the order of about micrometer (μm), and has an irregular shape. Said Al₂O₃ particles were placed first in the dilute acid solution (about 2 wt % H₂SO₄ aqueous solution), and is vibrated with a ultrasonic vibrator for 30 minutes to disperse Al₂O₃ particles and remove the dirt on the surface of Al₂O₃ particles so as to activate atoms on in surface of Al₂O₃ particles. Thereafter, Al₂O₃ particles were filtered off and placed in de-ionized water for cleaning under vibration and remove the dilute acidic aqueous solution remained on the surface of Al₂O₃ particles.

After accomplishing the pretreatment, Al₂O₃ particles were placed in an aqueous solution containing stannous ion (SnCl₂+HCl) and were stirred for 2 minutes to adhere a layer of tin-containing film over the surface of Al₂O₃ particles. Thereafter, Al₂O₃ particles were filtered and placed in de-ionized water for cleaning with stirring to remove the sensitization solution remained on the surface of the Al₂O₃ particles.

Next to the sensitization treatment, Al₂O₃ particles were placed in an aqueous solution containing palladium ion (PdCl₂+HCl) and stirred for about 30 minutes to adhere a layer of Pd-containing thin film on the surface of Al₂O₃ particles. Thereafter, Al₂O₃ particles were filtered, placed in de-ionized water and stirred to remove the activation solution remaining on the surface of Al₂O₃ particles.

After the activation treatment, Al₂O₃ particles were placed in an aqueous solution containing iron, and nickel ions (a plating bath formulation as listed in the following Table (1)) and were stirred for about 1 hour to deposit a layer of Fe—Ni metal over the surface of Al₂O₃ particles. Then, Al₂O₃ particles were filtered off and were placed in de-ionized water, whereby they were stirred to remove the eletroless plating solution remained on the surface of Al₂O₃ particles.

TABLE 1
The composition of the electroless plating
solution and operation parameters

| Component or | Chemical | Concentration |
|---|---|---|
| parameter | formula | or value |
| Nickel chloride | NiCl₂.6H₂O | 50 (g/L) |
| Sodium hypophosphite | NaH₂PO₂.H₂O | 25 (g/L) |
| Ferrous chloride | FeCl₂.4H₂O | 50 (g/L) |
| Ammonium hydroxide | NH₄OH | 60 (g/L) |
| Sodium potassium | KNa C₄H₄O₆ | 10 (g/L) |
| tartarate | | |
| pH | | 10 |
| Temperature | | 75° C. |

After completing the electroless plating, Al₂O₃ particles were placed in a growing furnace under a N₂ atmosphere (flow rate of N₂ gas was 120 c.c/min), and were heated to 700° C., and kept at 700° C. for half an hour to make physical and chemical properties of the catalytic Fe/NI nanoparticles uniform. Thereafter, the N₂ atmosphere was replaced with CH₄ gas (flow rate=120 c.c/min). At this temperature, CH₄ adhered on the surface of the catalytic Fe/Ni nanoparticles would decompose into C and H₂, as shown in the following equation:
CH_{4(g)}→C₍ₛ₎+2H_{2(g)}

In this course, carbon (s) on the surface of the catalytic Fe/Ni nanoparticles could grow into carbon nanotube or nanofiber. Thereafter, the atmosphere in the growing furnace was changed into N₂ gas (flow rate=120 c.c/min) and the furnace temperature was cooled down slowly to room temperature. The conditions for growing the carbon nanotube and nanofiber were listed in the following Table (2).

TABLE 2
Conditions for growing carbon nanotube or nanofiber

| | | | | | Flow rate |
|---|---|---|---|---|---|
| Step | Process | Temperature | Time | Atmosphere | (c. c/min) |
| 1 | Heating | Rising to | 40 | N₂ | 120 |
| | | 700° C. | min. | | |
| 2 | Preheating | 700° C. | 30 | N₂ | 120 |
| | | | min. | | |
| 3 | Growth | 700° C. | 30 | CH₄ | 120 |
| | | | min. | | |
| 4 | Cooling | Lowering to | 3 | N₂ | 120 |
| | | room | hours | | |
| | | temperature | | | |

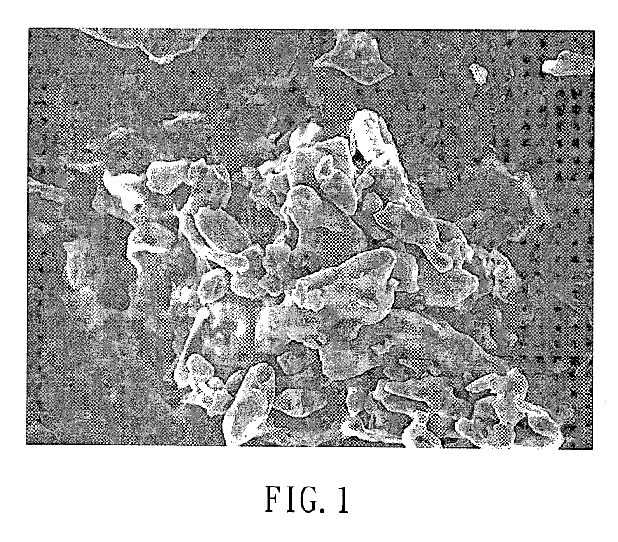

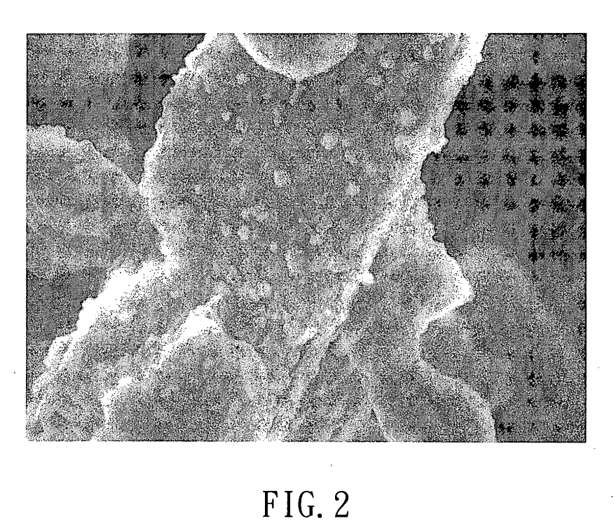

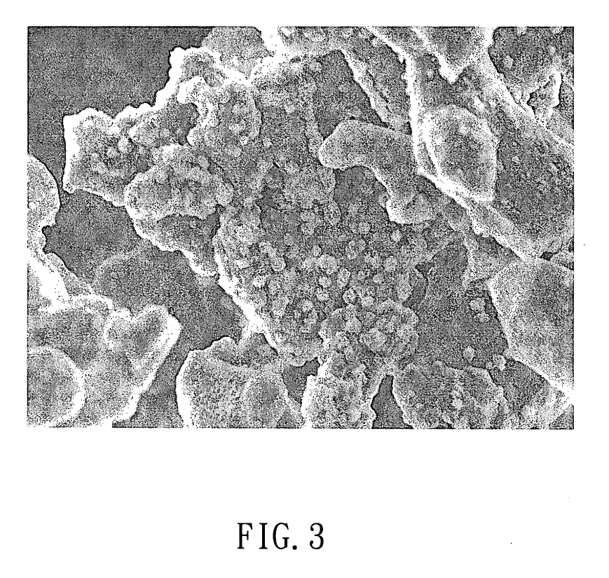

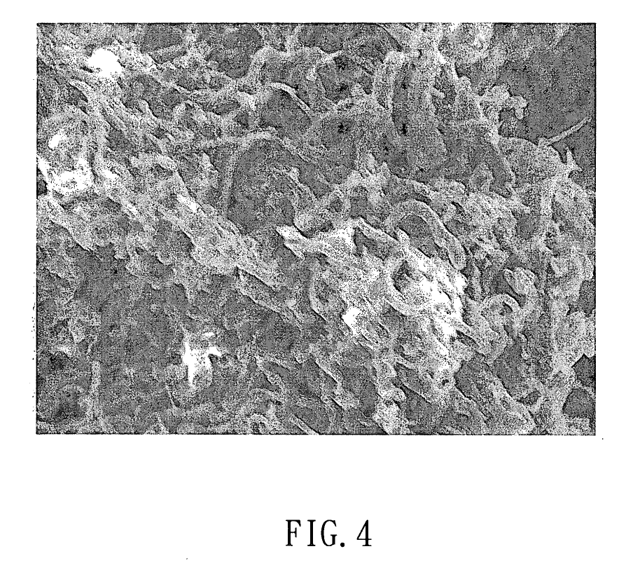

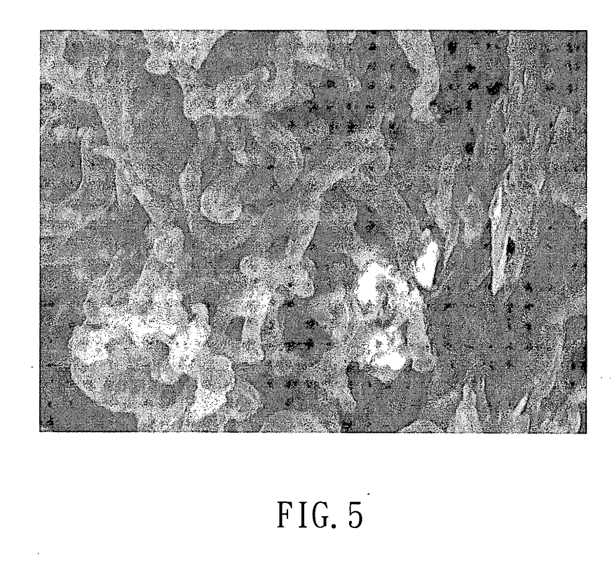

Now referring to FIG. 1-5, these are magnified images of powders containing carbon nanotube or nanofiber obtained in Examples according to the invention. FIG. 1 shows an image of a selected Al₂O₃ carrier obtained under a field emitting scanning electron microscope (FESEM) at a magnification of 20,000×, and shows the irregular shape of Al₂O₃ particles. FIG. 2 is a magnified image of products formed by electroless depositing Fe/Ni catalyst over the surface of Al₂O₃ carriers under FESEM at a magnification of 100,000×, and shows that the catalyst Fe/Ni nano-particles are adhered sparsely on the surface of the Al₂O₃ carrier. FIG. 3 is a magnified FESEM image of products formed by electroless depositing Fe/Ni catalyst over the surface of Al₂O₃ carriers for 20 minutes, it can be seen that Fe/Ni catalyst nano-particles are significantly increased. FIG. 4 is a magnified FESEM image at a magnification of 20,000× of carbon nanotube or nanofiber grown in this example, wherein the carbon nanotube or nanofiber is in a thin, elongate and curved shape, and there are numerous large or small pores among carbon nanotube or nanofiber, whereby they play an important role on the adsorption behavior of the carbon nanotube or nanofiber. FIG. 5 is the FESEM image of the carbon nanotube or noanfiber grown in this example and shows that they have a length in the order of micrometers and a diameter of several tens nanometer.

Thus, the invention produces a powder containing a carbon nanotube or nanofiber by a process comprising of plating a layer of metal or alloy catalyst of Fe, Co, Ni, Fe/Ni, Fe/Co, Co/Ni, or Fe/Co/Ni over the surface of Al₂O₃, SiO₂, TiO₂, CaO, SiC, WC particles and the like (with a size of micrometer) as a carrier by means of electroless plating technique, followed by growing a carbon nanotube or nanofiber on the surface of the carrier via a chemical vapor deposition process (CVD), where the powder containing a carbon nanotube or nanofiber thus obtained exhibits following advantages:
(1) Since the carbon nanotube or nanofiber has been grown directly on said particles and presents as curved and crossover shape, numerous large or small pores can be formed between tubes/fibers, and thereby improves greatly their adsorption capacity.
(2) Since the carbon nanotube or nanofiber has been grown directly on said micro-particles and to be applied directly for adsorption, the tube/fiber tends not to loss, and is readily to be reused by filtration and regeneration.
(3) Since the carbon nanotube or nanofiber has been grown directly on the micro-particles and these micro-particles such as Al₂O₃, SiO₂, TiO₂, CaO, SiC, and WC are chemically stable to cause no secondary pollution.
(4) Since the carbon nanotube or nanofiber has been grown on the micro-particles by an electroless plating technique and a chemical vapor deposition technique, the associated equipments and operation cost are relative inexpensive, and is suitable for mass production.

While the invention has been described in the foregoing by way of some practicable embodiments thereof, it is understood that these are not intended to limit the scope of the invention and that one skilled in the relative art can made many apparent changes and application embodiments thereto without departing from the essential context of the invention.

Accordingly, the invention can accomplish its intended object, and provide a process for producing a powder containing a carbon nanotube or nanofiber, whereby said powder may be used for the adsorption of pollutants in the environment. Further, since the powder and its production process disclosed by the invention have never appeared in known literature or art, the invention exhibits obviously a novelty, an usefulness and an inventive step, and is intended to file for an invention patent accordingly.

What is claimed is:

1. A powder containing a carbon nanotube or nanofiber, comprising a carrier and a carbon nanotube or nanofiber, wherein said carrier has an average diameter in an order of micrometer, and said carbon nanotube or nanofiber is adhered on the surface of said carrier.

2. A powder containing a carbon nanotube or nanofiber as in claim 1, wherein said carrier is a ceramic particle selected from the group consisting of alumina (Al₂O₃), silicon dioxide (SiO₂), titanium dioxide (TiO₂), calcium oxide (CaO), silicon carbide (SiC), or tungsten carbide (WC).

3. A powder containing a carbon nanotube or nanofiber as in claim 1, wherein said carbon nanotube or nanofiber is formed by plating a layer of catalyst on the surface of the carrier through an electroless plating technique, followed by growing on the surface of the carrier by a chemical vapor deposition process (CVD).

4. A powder containing a carbon nanotube or nanofiber as in claim 3, wherein said catalyst on the surface of the carrier comprises iron (Fe), cobalt (Co), nickel (Ni), iron/nickel alloy (Fe/Ni), iron/cobalt alloy (Fe/Co), cobalt/nickel alloy (Co/Ni) or iron/cobalt/nickel alloy (Fe/Co/Ni).

5. A process for producing a powder containing a carbon nanotube or nanofiber, comprising steps of:
(1) pretreatment: cleaning a carrier in a washing solution to remove dirt on the surface of the carrier, followed by rinsing in de-ionized water to remove the cleaning solution remained on the surface of the carrier;
(2) sensitization treatment: placing said carrier thus cleaned in a sensitization solution to coating the carrier with a thin layer containing tin, followed by rinsing in de-ionized water to remove the sensitization solution remained on the surface of the carrier;
(3) activation treatment: placing the sensitized carrier in an activation solution to adhere a layer of palladium over the surface of the carrier, followed by rinsing in de-ionized water to remove the activation solution remained on the surface of the carrier;
(4) electroless plating: placing the activated carrier in an electroless plating solution to plate a layer of metal or alloy catalyst on the surface of the carrier, followed by rinsing in de-ionized water to remove the eletroless plating solution remained on the surface of the carrier;
(5) growing treatment: placing the electroless plated carrier in a growth furnace to grow a carbon nanotube or nanofiber over the surface of the carrier in an atmosphere containing a carbon source.

6. A process for producing a powder containing a carbon nanotube or nanofiber as in claim 5, wherein said cleaning solution used in said pretreatment is an acidic aqueous solution containing hydrochloric acid (HCl), sulfuric acid (H₂SO₄) or hydrofluoric acid (HF), and the pretreatment comprises a vibration cleaning by a ultrasonic vibrator.

7. A process for producing a powder containing a carbon nanotube or nanofiber as in claim 5, wherein said sensitization solution used in said sensitization step is an aqueous solution containing stannous chloride (SnCl₂) and hydrochloric acid (HCl), and the sensitization treatment is carried out by stirring sensitization with a stirrer.

8. A process for producing a powder containing a carbon nanotube or nanofiber as in claim 5, wherein said activation solution used in said activation treatment is an aqueous solution containing palladium chloride (PdCl₂) and hydrochloric acid (HCl), and said activation treatment is carried out by stirring activation with a stirrer.

9. A process for producing a powder containing a carbon nanotube or nanofiber as in claim 5, wherein said electroless plating solution used in said electroless plating step is an aqueous solution containing one of Fe ion, Co ion, Ni ion, Fe ion and Co ion, Fe ion and Ni ion, Co ion and Ni ion, or Fe ion and Co ion and Ni ion, and said electroless plating is carried out by stirring with a stirrer.

10. A process for producing a powder containing a carbon nanotube or nanofiber as in claim 5, wherein said growth step is proceeded by a preheating said carrier in an atmosphere of nitrogen (N₂), argon (Ar) or hydrogen (H₂) at a temperature of 400˜800° C. for a period of time till the physical and chemical properties is uniform.

11. A process for producing a powder containing a carbon nanotube or nanofiber as in claim 5, wherein said carbon-containing atmosphere used in said growth step contains a carbon source including CH₄, C₂H₂, C₃H₈, and C₂H₅OH gases, and wherein the gas to be supplied into the growth furnace can flow concurrently with the input of N₂, H₂, or Ar gases.

12. A process for producing a powder containing a carbon nanotube or nanofiber as in claim 5, wherein the pressure in said growth furnace is at normal pressure or at a pressure less than a normal pressure.

13. A process for producing a powder containing a carbon nanotube or nanofiber as in claim 5, wherein said carbon nanotube or nanofiber is grown at a temperature in the range of 600° C. to 900° C.

14. A process for producing a powder containing a carbon nanotube or nanofiber as in claim 5, wherein said carrier is a ceramic particle selected from the group of alumina (Al₂O₃), silicon dioxide (SiO₂), titanium dioxide (TiO₂), calcium oxide (CaO), silicon carbide (SiC), or tungsten carbide (WC).
